(19) United States
(12) Patent Application Publication
(10) Pub. No.: US 2006/0133309 A1
(43) Pub. Date: Jun. 22, 2006

(54) Methods for synchronization of communications between a circuit switched network and a packet data network

(76) Inventors: James E. Mathis, Barrington, IL (US); Matthew C. Keller, Algonquin, IL (US); Ross J. Lillie, Hoffman Estates, IL (US); Donald G. Newberg, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/019,067

(22) Filed: Dec. 21, 2004

(51) Int. Cl. H04J 3/06; H04Q 7/00

(52) U.S. Cl. 370/328; 370/503

(57) ABSTRACT

Methods for synchronization in a RF communication system are disclosed. At a mobile device, frames are received from a circuit switched network wherein at least one frame has a first timestamp wherein the first timestamp is related to a time base for a source of communications. Packets are also received from a packet data network wherein each packet comprises a second timestamp from the time base. Frames and packets are sequenced based upon the first timestamp and the second timestamp.

### FIELD OF THE INVENTION

The present invention relates generally to wireless communication systems and in particular to the field of synchronization in wireless communication systems.

### BACKGROUND

Having a mobile device which is capable of communicating over a traditional circuit switched network, such as a radio network, as well as a packet data network is important if the mobile device wishes to receive communications simultaneously over the two networks or if the mobile device wishes to switch between the two networks. For example, the mobile device may wish to receive a first communication stream, such as voice, over the circuit switched network and simultaneously receive a second communication stream, such as video, over the packet data network. Because the mobile device will be receiving two different communication streams from the two networks, there is a need to synchronize the first communication stream with the second communication stream.

In addition, when the mobile device moves between areas serviced by a circuit switched network and areas serviced by a packet data network, the mobile device needs to be able to synchronize the information received from the circuit switched network interface to the information received from the packet data network interface. Further, when the mobile device moves between the two areas, the communication unit needs to be able to handoff between the two networks without affecting the communication taking place by the mobile device. For example, when a police officer moves from his squad car toward a building and enters the building, the police officer should be able to continue his/her conversation using the same communication unit and without having his communication delayed or dropped. Accordingly, there is a need for synchronization of communications between a circuit switched network and a packet data network.

### BRIEF DESCRIPTION OF THE FIGURES

The present invention is illustrated by way of example and not limitation in the accompanying figures, in which like references indicate similar elements, and in which:

FIG. 1 is an example of a simple block diagram illustrating an RF communication system in accordance with some embodiments of the invention.

FIG. 2 is a flow chart illustrating a method for a sending mobile device to synchronize voice streams in accordance with some embodiments of the invention.

FIG. 3 is a flow chart illustrating a method for a receiving mobile device to synchronize voice streams in accordance with some embodiments of the invention.

FIG. 4 is a flow chart illustrating a method for a sending mobile device to synchronize voice and packet data streams in accordance with some embodiments of the invention.

FIG. 5 is a flow chart illustrating a method for a receiving mobile device to synchronize voice and packet data streams in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail synchronization in accordance with an embodiment of the present invention, it should be observed that the present invention resides primarily in combinations of method steps and apparatus components related to synchronization. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

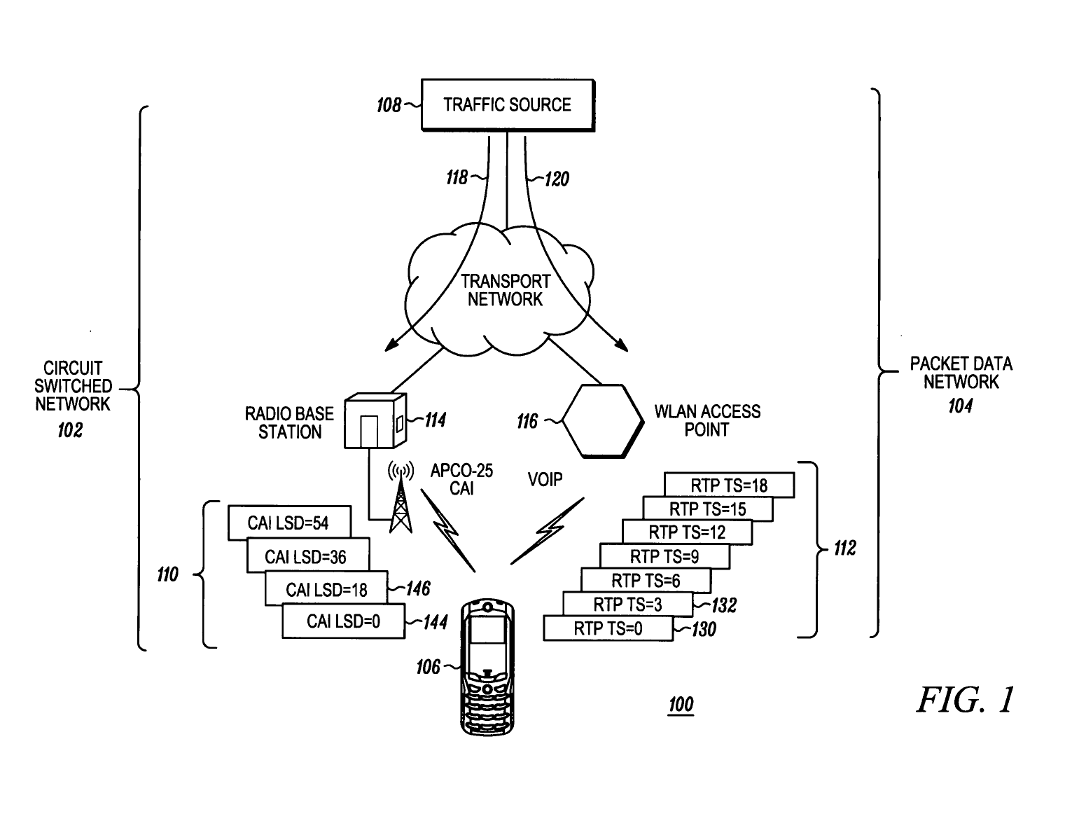

A method and apparatus for synchronizing two communication streams is disclosed. Referring to FIG. 1, a radio frequency (RF) communication system 100 according to an embodiment of the present invention illustratively comprises a traffic source 108 which sends two communication streams to a mobile device 106 over a wireless network where the wireless network comprises one communication stream which is a circuit switched network 102 and a second communication stream which is a packet data network 104. The traffic source 108 is a part of the RF communication system 100 that transmits information, e.g. voice and/or media communications.

The circuit switched network 102 comprises a first wireless communication resource 118 and intermediate nodes, such as a base station 114. FIG. 1 only shows one intermediate node, namely base station 114, for the purpose of ease of illustration. However, it should be understood by those of ordinary skill in the art that the circuit switched network 104 may be designed with any number of intermediate nodes. An example of the circuit switched network 102 is a radio network such as a radio network that adheres to an APCO 25 communications standard.

As is known in the art, in a circuit switched network, such an APCO radio network, for a communication to take place, a circuit is set up between two endpoints, e.g. mobile devices, before a communication takes place. Further, the communication is carried in frames, where frames are logical units of data having a header, payload and a trailer. It is important to note that the frames in a circuit switched network do not carry timestamp information since the frames in the circuit switched network are sequentially processed and do not need to be ordered.

As will be appreciated, the first wireless communication resource 118 may comprise any of the currently available resources, such as, for example, radio frequency (RF) technologies, including, but not limited to Code Division Multiple Access (CDMA), Time Division Multiple Access (TDMA), Frequency Division Multiple Access (FDMA), and the like. Moreover, an embodiment of the present invention may be used in any currently available radio network, such as, for example, Global System for Mobile communication (GSM), General Packet Radio Service (GPRS), Universal Mobile Telecommunications Service (UMTS), Trans-European Trunked Radio service (TETRA), Association of Public Safety Communication Officers (APCO) Project 25, Personal Communication Service (PCS), Advanced Mobile Phone Service (AMPS) and the like. In the alternative, other wireless technologies, such as those now known or later to be developed and including, but not limited to, infrared, Bluetooth, electric field, electromagnetic, or electrostatic transmissions, may likewise suffice.

In accordance with the present invention, the first wireless communication resource 118 comprises multiple RF channels such as pairs of frequency carriers, TDMA time slots, CDMA channels, and the like. In the case where the first wireless communication resource 118 comprises RF channels, it is common to assign separate channels and/or separate radio base stations for different types of communication traffic. Thus, base radio stations at various sites (not shown) may comprise control channels, voice channels and/or links.

In contrast, the packet data network 104 comprises a second wireless communication resource 120 and an access point (AP) 116 to support Internet Protocol (IP) addressing of packets. As is known in the art and as used herein, packets are units of payload and are not sequentially processed by the packet data network 104. FIG. 1 only shows one AP 116 for the purpose of ease of illustration. However, it should be understood by those of ordinary skill in the art that the packet data network 104 may be designed with any number of access points.

In one embodiment, the packet data network 104 may be an 802.11 wireless local area network (WLAN), wherein the mobile device 106 and the AP 116 are configured to operate in accordance with the ANSI/IEEE (American National Standards Institute/Institute of Electrical and Electronics Engineers) 802.11 wireless LAN standards. Alternatively, the packet data network 104 may adhere to another ANSI/IEEE 802 wireless standard, such as 802.15.1, 802.15.3, 802.15.4, 802.16, 802.20, 802.22, and the like. The mention of ANSI/IEEE 802.11 is not to be construed as a limitation.

Practitioners skilled in the art will appreciate that the RF communication system 100 may include various other communication devices not specifically shown in FIG. 1. For example, the circuit switched network 102 may comprise a link, such as, for example a T1 line or E1 digital carrier system that connects the base station 114 to a public switched telephone network (PSTN) via a telephone gateway, a paging network or short message system via a paging gateway, and a facsimile machine or similar device via fax gateway or modem.

In addition, the packet data network 104 may be connected via the AP 116 to an underlying network that may be implemented, for instance, as a wired network or as a mesh network having fixed or mobile access points. Further, the packet data network 104 may provide access to a number of content sources, such as the Internet or various Intranets. In support thereof, the packet data network 104 may include any number or type of wire line communication device(s), site controller(s), comparator(s), telephone interconnect device(s), internet protocol telephony device(s), call logger(s), scanner(s) and gateway(s, collectively referred to herein as a fixed device(s).

In any event, the endpoint of communication in the RF communication system 100 is a mobile device 106 which is generally a communication device that may be either a source or recipient of payload and/or control messages routed through the RF communication system 100. Mobile device 106 may be any suitable type of wireless communications device capable of communicating within the RF communication system 100, for instance, a laptop computer, a personal digital assistant, a voice handset, or any other suitable device as will be appreciated by those of skill in the art. The mobile device may also be connected to a fixed communications infrastructure, if desired.

In operation, the mobile device 106 may roam from a first coverage area serviced by the circuit switched network 102 to a second coverage area serviced by the packet data network 104 while receiving a communication from a communication device, e.g. traffic source 108. As mentioned above, the traffic source 108 is a part of the RF communication system 100 that transmits information, e.g. voice and/or media communications.

Thus, the mobile device 106 may receive a first communication stream 110 from the circuit switched network 102 and a second communication stream 112 from the packet data network 104, both of which correspond to the communication from the traffic source 108. Since the transmission path via the circuit switched network 102 will show different delays and variance in delays from the transmission path via the packet data network 104, the mobile device 106 needs to synchronize the two different communication steams 110, 112. In an embodiment of the present invention, the mobile device 106 will need to know how to synchronize the two communication streams 110, 112 so that the mobile device 106 can switch without disruption between the two networks.

In an embodiment of the present invention, timestamps comprising sequencing information are embedded into the first communication stream 110 to provide such synchronization. As mentioned before, the timestamp embedded into the first communication stream 110 is not normally embedded into the first communication stream 110 because the first communication stream 110 is a part of a circuit switched network 102 which does not require sequencing information for a communication to take place.

In an embodiment of the present invention, a second mobile device (not shown) is unaffected by the first communication stream 110 having timestamps. Thus, the second mobile device is able to ignore the timestamps that are embedded into the first communication stream 110 and is able to process the first communication stream 110 as if the embedded sequencing information were not there.

In an alternative embodiment, the RF communication system 100 has knowledge of whether the mobile devices in the RF communication system 100 are able to process the timestamps comprising embedding sequencing information or not. With that knowledge, the RF communication system 100 sends the first communication stream 110 either with the timestamps having embedded sequencing information or not. In one embodiment, the knowledge of whether the mobile devices are capable of processing timestamps is kept at intermediate nodes, e.g. the base station 104. In an alternative embodiment, the knowledge of whether the mobile devices are capable of processing timestamps is kept at the traffic source 108.

In an embodiment of the present invention, the sequencing information is an RTP time stamp. The RTP timestamp defines playback synchronization points and reflects the passage of time during a communication. In one embodiment, the RTP time stamp is conveyed in a manufacturer specific Link Control Word (LCW) format and is conveyed in 32 bits. In a second embodiment, the RTP time stamp is conveyed in low speed data bits in the APCO frame. Either embodiment conveys the RTP time stamp but the second embodiment is preferential for mobile devices that only work on an APCO-25 system.

The communication may be voice, video, or a multi-media communication encompassing both voice and video. Further, the communication may originate from a mobile device that is a legacy device which is not capable of generating a Real Time Protocol (RTP) time stamp. The time stamp is information that conveys a sequence number so that packets can be reassembled in order of transmission. In such a case, an intermediate node may generate the RTP time stamp and may otherwise act as the traffic source in this description.

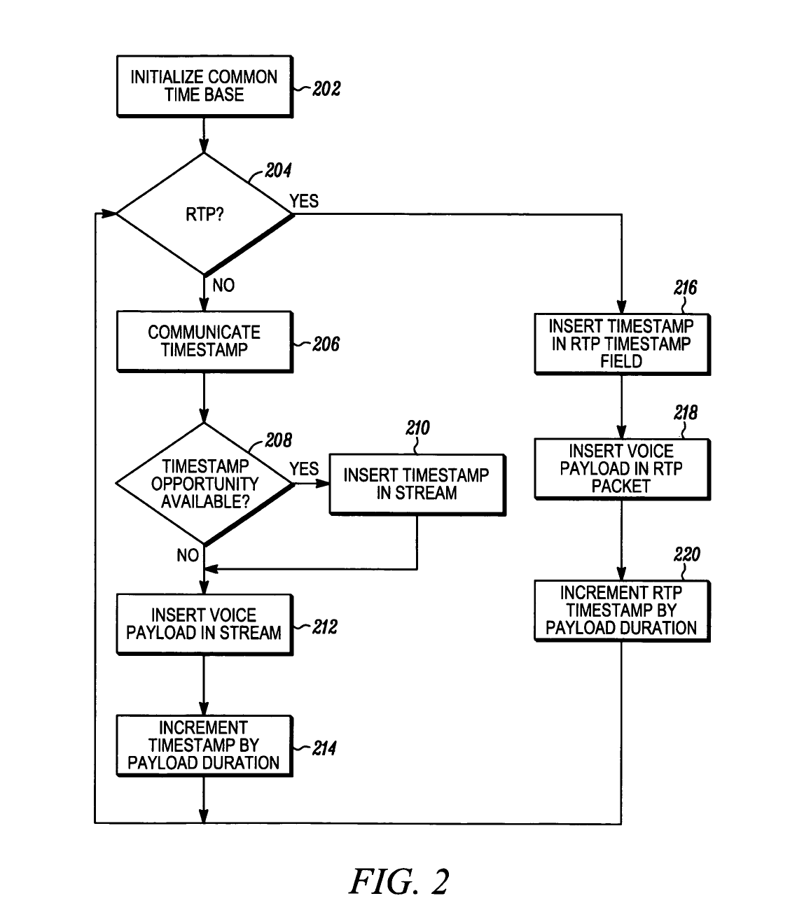

Shown in FIG. 2 is a flow chart for the process performed by a sender of a communication where the sender synchronizes a voice communication of a circuit switched network 102 with a voice communication of a packet data network 104. An example sender is a mobile device 106 of FIG. 1. A traffic source such as 108 initializes a common time base (Block 202). Initializing a common time base is described in the IETF RTP specification. If the communication stream to be created is one in which a RTP timestamp is required (Block 204), then the RTP timestamp is inserted into the RTP timestamp field of each packet of the communication stream (Block 216). Then, the voice payload is inserted into the data portion of the packet (Block 218). Finally, the RTP timestamp is incremented by the duration of the voice payload (Block 220).

If the communication stream to be created is not one in which a RTP timestamp is a part of the communication protocol (Block 204), then the RTP timestamp is communicated to a base station 114 of the circuit switched network (Block 206). At the base station, the base station determines whether it is a timestamp opportunity (Block 208). If it is, then the communicated RTP timestamp is embedded into a voice frame of the first communication stream (Block 210). As used herein, in an APCO 25 embodiment of the present invention, an APCO frame carries 18 units of encoded voice and is sequentially processed by the circuit switched network 102. In any case, then the voice payload is inserted into the first communication stream (Block 212) and the timestamp is incremented by the duration of the voice payload (Block 214).

In one embodiment, the RTP timestamp is transmitted as low-speed data that is embedded with voice frames of the first communication stream. In a second embodiment, unused bits in the header or payload may be used as a low-rate data communications channel. In either case, the first communication stream is marked with timestamps that correspond to the RTP timestamps of the second communication stream.

Shown in FIG. 1 is an example of how synchronization according to an embodiment of the present invention works. Shown in FIG. 1 is a second communication stream with RTP packets 112 where the common time base is initialized to 0 and is incremented at 3 units owing to the duration of the voice payload included in the RTP packet. Assuming that the common time base is initialized to 0 and that the time stamp is incremented by one unit for each unit of encoded voice conveyed in the RTP packet, then RTP packet 130 has a time stamp of 0, RTP packet 132 has a time stamp of 3, and so on. In the first communication stream of APCO frames 110, opportunities to communicate the timestamp are defined by the APCO air interface and may be different from the opportunities to communicate the timestamp via the RTP packets. Thus the time base increment value for APCO may be different from that for RTP packets. In one embodiment where the timestamp is transmitted as low-speed data, the time base is incremented by 18, where 18 specifies a duration between timestamp opportunities and corresponds to one APCO frame. In the circuit switched network 102 where the first communication stream 110 carries APCO frames, assuming that the common time base is initialized to 0 and that each APCO frame has a low-speed data (LSD) field with the RTP time stamp, then APCO frame 144 has a time stamp of 0, APCO frame 146 has a time stamp of 18, and so on.

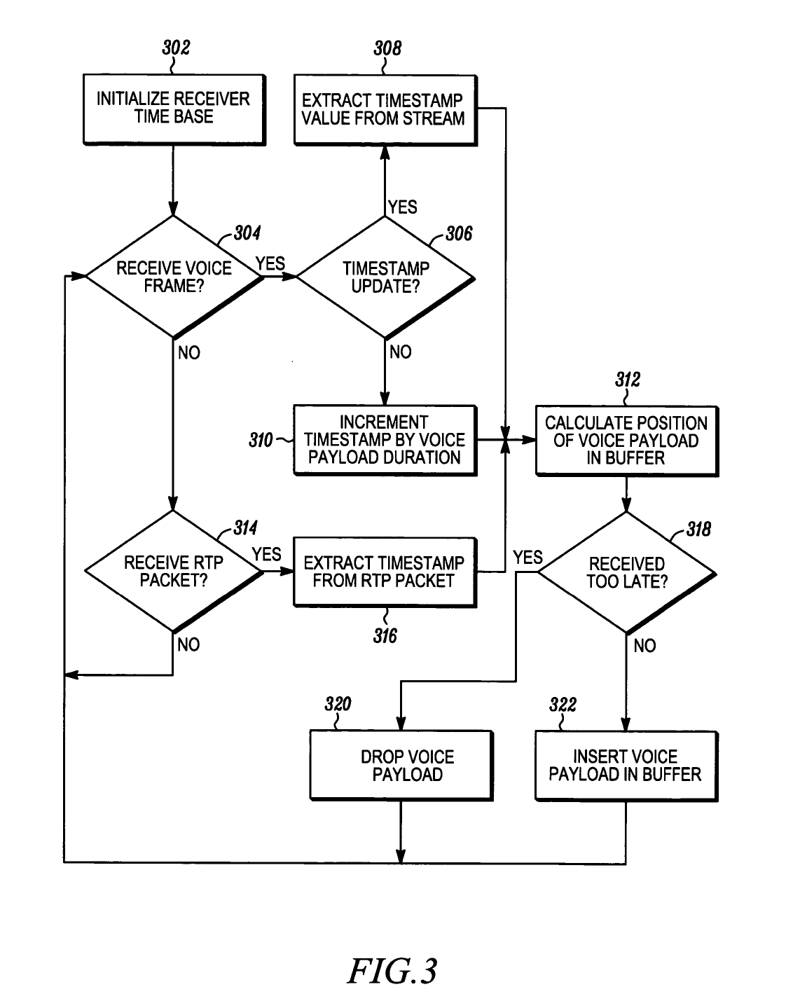

Shown in FIG. 3 is a flow chart for the process performed by a receiver of a communication where the receiver synchronizes a voice communication of a circuit switched network 102 with a voice communication of a packet data network 104. An example receiver is a mobile device 106 of FIG. 1. The receiver initializes a time base (Block 302). Initializing a time base is described in the RTP specification. If the receiver receives a voice frame having voice payload (Block 304), then the receiver checks to see if a timestamp is updated (Block 306). If a timestamp update has been received (Block 306), then the receiver extracts the RTP timestamp from the communication stream (Block 308). If a timestamp update has not been received (Block 306), then the timestamp is incremented by the duration of the voice payload (Block 310).

If the receiver did not receive a voice frame (Block 304), then the receiver checks to see if it received a RTP packet having voice payload (Block 314). If the receiver did receive a RTP packet (Block 314), then the receiver extracts the timestamp from the RTP packet (Block 316).

In any case, when the receiver has received voice payload, it calculates a position for where to place the voice payload in a buffer of the receiver (Block 312). If the received voice payload has a timestamp that is not too late to be played back based upon the calculated position (Block 318), then the receiver places the voice payload in the buffer. If the received voice payload has a timestamp that is too late to be played back (Block 318), then the voice payload is dropped (Block 320).

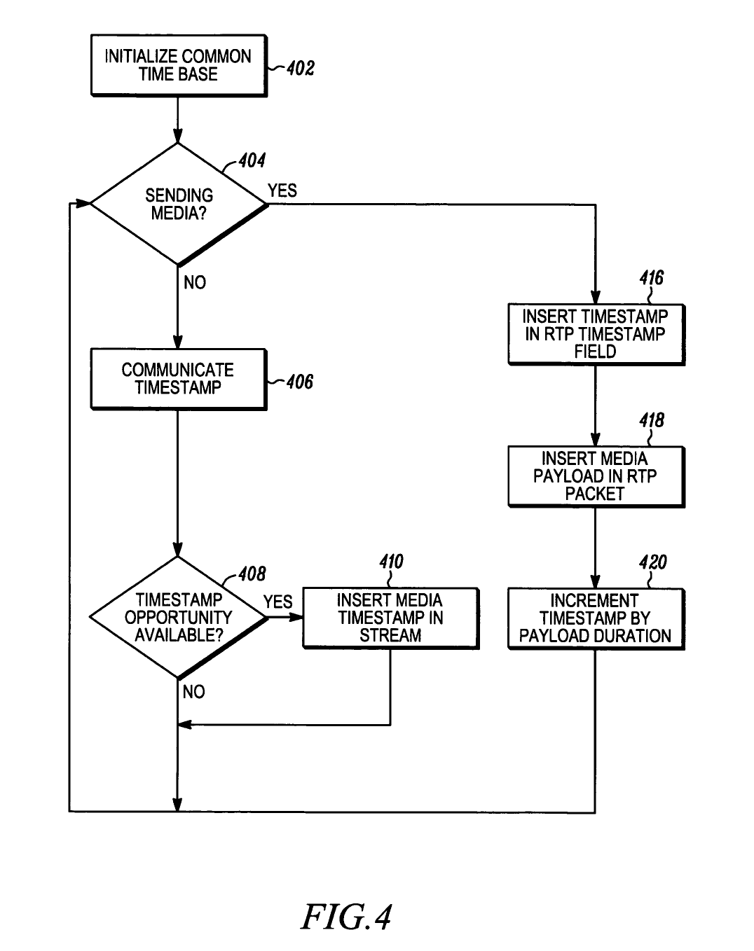

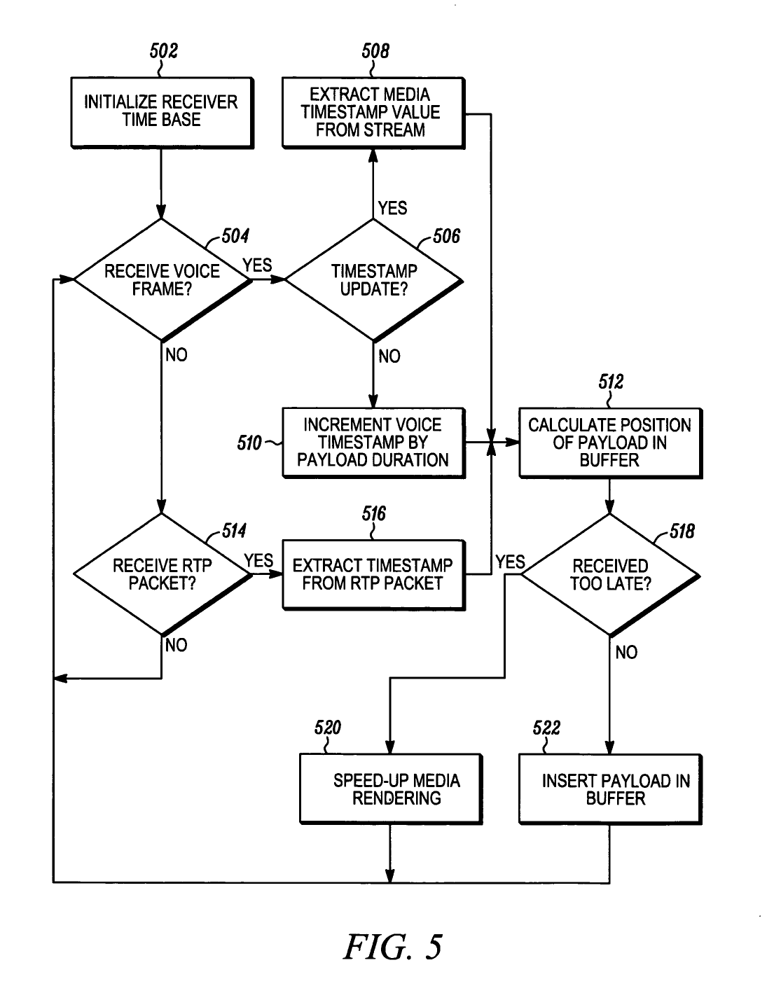

Similar to the voice communication of FIGS. 2 and 3, shown in FIGS. 4 and 5 are the activities performed in processing media payload. Shown in FIG. 4 is a flow chart for the process performed by a sender of a communication where the sender synchronizes voice communication of a circuit switched network 102 with media communications of a packet data network 104. An example sender is a mobile device 106 of FIG. 1. A traffic source such as 108 initializes a common time base (Block 402). As with FIG. 2, initializing a common time base is described in the IETF RTP specification. If the communication stream is a media communication in which a RTP timestamp is required (Block 404), then the RTP timestamp is inserted into the RTP timestamp field of each packet of the communication stream (Block 416). Then, the media payload is inserted into the data portion of the packet (Block 418). Finally, the RTP timestamp is incremented by the duration of the media payload (Block 420).

If the communication stream to be created is not a media communication in which a RTP timestamp is a part of the communication protocol (Block 404), then the RTP timestamp is communicated to a base station 114 of the circuit switched network (Block 406). At the base station, the base station determines whether it is a timestamp opportunity (Block 408). If it is, then the communicated RTP timestamp is embedded into a voice frame of the first communication stream (Block 410).

As mentioned while describing FIGS. 2 and 3, in one embodiment, the RTP timestamp is transmitted as low-speed data that is embedded with voice frames of the first communication stream. In a second embodiment, unused bits in the header or payload may be used as a low-rate data communications channel. In either case, the first communication stream is marked with timestamps that correspond to the RTP timestamps of the second communication stream.

Shown in FIG. 5 is a flow chart for the process performed by a receiver of a communication where the receiver synchronizes a voice communication of a circuit switched network 102 with a media communication of a packet data network 104. An example receiver is a mobile device 106 of FIG. 1. The receiver initializes a time base (Block 502). As with FIG. 3, initializing a time base is described in the IETF RTP specification. If the receiver receives a voice frame having voice payload (Block 504), then the receiver checks to see if the timestamp is updated (Block 506). If a timestamp update has been received (Block 506), then the receiver extracts the RTP timestamp from the communication stream (Block 508). If a timestamp update has not been received (Block 506), then the timestamp is incremented by the duration of the voice payload (Block 510).

If the receiver did not receive a voice frame (Block 504), then the receiver checks to see if it received a RTP packet having media payload (Block 514). If the receiver did receive a RTP packet (Block 514), then the receiver extracts the timestamp from the RTP packet (Block 516).

In any case, when the receiver has received payload, whether voice or media, it calculates a position for where to place the payload in a buffer of the receiver (Block 512). As is known in the art, the buffer may be a combined buffer where both voice and media are stored for further processing. If the received payload has a timestamp that is not too late to be played back based upon the calculated position (Block 518), then the receiver places the payload in the buffer (Block 522). If the received media payload has a timestamp that is out of synchronization with the voice payload, the synchronization of the voice is brought in line with the media. In one embodiment, this is done by adjusting the speed of the media rendering (Block 520).

It will be appreciated the synchronization described herein may be comprised of one or more conventional processors and unique stored program instructions that control the one or more processors to implement, in conjunction with certain non-processor circuits, some, most, or all of the functions of the synchronization described herein. The non-processor circuits may include, but are not limited to, a radio receiver, a radio transmitter, signal drivers, clock circuits, power source circuits, and user input devices. As such, these functions may be interpreted as steps of a method to perform synchronization. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for synchronization in a RF communication system comprising the steps of:
at a mobile device:
receiving frames from a circuit switched network wherein at least one frame has a first timestamp wherein the first timestamp is related to a time base for a source of communications;
receiving packets from a packet data network wherein each packet comprises a second timestamp from the time base; and
sequencing payload of the frames and packets based upon the first timestamp and the second timestamp.

2. The method of claim 1 wherein the circuit switched network is a radio network chosen from the list comprising Global System for Mobile communication (GSM), General Packet Radio Service (GPRS), Universal Mobile Telecommunications Service (UMTS), Trans-European Trunked Radio service (TETRA), Association of Public Safety Communication Officers (APCO) Project 25, Personal Communication Service (PCS), and Advanced Mobile Phone Service (AMPS).

3. The method of claim 1 wherein the frames and packets comprise voice communications of the RF communication system.

4. The method of claim 3 wherein the step of sequencing payload further comprises:
maintaining a voice buffer comprising voice communications and a position pointer;
extracting the first timestamp from a frame of the received frames;
calculating a position of the voice buffer from the extracted first timestamp; and
placing the payload in the voice buffer corresponding to the calculated position, if the payload has a timestamp that is not too late for playback based upon the calculated position.

5. The method of claim 4 further comprising dropping the frame, if the payload has a timestamp that is too late for playback based upon the calculated position.

6. The method of claim 4 further comprising updating the position based upon a duration of the payload.

7. The method of claim 3 wherein the step of sequencing payload further comprises:
maintaining a voice buffer comprising voice communications and a position pointer;
extracting the second timestamp from a packet of the received packets;
calculating a position of the voice buffer from the extracted second timestamp; and
placing the payload in the voice buffer corresponding to the calculated position, if the payload has a timestamp that is not too late for playback based upon the calculated position.

8. The method of claim 1 wherein the frames comprise voice communications and packets comprise media communications of the RF communication network.

9. The method of claim 8 wherein the step of sequencing payload further comprises:
maintaining a playback buffer comprising voice and media communications and a position pointer;
extracting the first timestamp from a frame of the received frames;
calculating a first position of the playback buffer from the extracted first timestamp;
placing the payload of the frame in the playback buffer corresponding to the calculated first position;
extracting the second timestamp from a packet of the received packets;
calculating a second position of the playback buffer from the extracted second timestamp;
comparing the second timestamp with the calculated first position; and
placing the payload of the packet in the playback buffer corresponding to the calculated second position, if the payload of the packet has a timestamp that is not too late for playback based upon the calculated first position.

10. The method of claim 9 wherein the playback buffer is a combined buffer.

11. The method of claim 9 further comprising aligning the payload of the frame with the payload of the packet; if the payload of the packet has a timestamp that is out of synchronization with the payload of the frame.

12. The method of claim 1 further comprising inserting the first timestamp in the frames at a location chosen from the list comprising a traffic source and an intermediate node of the RF communication system.

13. The method of claim 1 further comprising the steps of:
at a second mobile device:
receiving frames the circuit switched network wherein at least one frame has a timestamp wherein the timestamp is related to a time base for a source of communications;
ignoring the timestamp in the frames; and
processing the payload of the frames.

14. A method for synchronization in a RF communication system comprising the steps of:
initializing a time base to be used for a first communication stream and a second communication stream;
creating sequence information comprising the time base;
inserting the sequence information into each packet of the second communication stream and frames of the first communication stream where at least one frame carries the sequence information;
transmitting the first communication stream and the second communication stream to a mobile device of the RF communication system; and
ordering each frame of the first communication stream and each packet of the second communication stream based upon the sequence information.

15. The method of claim 14 wherein the first communication stream is a product of a circuit switched network.

16. The method of claim 15 wherein the first communication stream adheres to a common air interface protocol chosen from the list comprising APCO 25 and TETRA.

17. The method of claim 15 wherein the second communication stream is a product of a packet data network.

18. The method of claim 15 wherein the second communication stream adheres to a wireless standard chosen from the list comprising ANSI/IEEE 802 and UMTS.

19. The method of claim 14 further comprising dropping either a frame or a packet if the frame or packet is received too late to be played back.

20. A method for synchronizing voice with media in a RF communication system comprising the steps of:
initializing a time base to be used for a APCO communication stream and a WLAN communication stream;
creating timestamp information comprising the time base;
inserting the timestamp information into each WLAN packet of the WLAN communication stream and some APCO frames of the APCO communication stream where at least one APCO frame carries the timestamp information;
transmitting the ACPO communication stream and the WLAN communication stream to a mobile device of the RF communication system; and
sequencing payload of each APCO frame of the APCO communication stream and each WLAN packet of the WLAN communication stream based upon the timestamp information.
